(19) United States
(12) Patent Application Publication
(10) Pub. No.: US 2026/0222374 A1
(43) Pub. Date: Jul. 30, 2026

(54) METHODS AND SYSTEMS FOR MANAGING INSTANT MESSAGE RECIPIENTS

(71) Applicant: DISH Network L.L.C., Englewood, CO (US)

(72) Inventors: Ryan Plummer, Shawsville, VA (US); Osabhie Ferguson, Blacksburg, VA (US); April Baik, Lone Tree, CO (US)

(21) Appl. No.: 19/040,571

(22) Filed: Jan. 29, 2025

(51) Int. Cl. H04L 51/04; G06F 3/0482

(52) U.S. Cl. CPC H04L 51/04; G06F 3/0482

(57) ABSTRACT

A technique is directed to methods and systems for managing dynamically adjusting instant message (IM) recipients in a group chat environment. In some implementations, the method includes (1) receiving a request for selecting one or more chat participants from an existing instant message chat group; (2) selecting the one or more chat participants in response to the request so as to determine a selected one or more chat participants; (3) generating an integrated working space for the user and the selected one or more chat participants to communicate by instant message; and (4) visually presenting the integrated working space in a user interface.

### BACKGROUND

Instant messages (IMs) are widely used for communications in various fields. Group chat functions enable multiple users to communicate by instant messages at the same time. Traditional group chat environment provides a drop-down list showing all the chat participants available for receiving a direct message. It can be difficult to navigate through multiple participants and locate a desirable candidate for sending direct messages, especially in events where there are a large number of participants. Therefore, it is advantageous to have an improved system and method to address the foregoing needs.

### BRIEF DESCRIPTION OF THE DRAWINGS

FIG. 1 is a schematic diagram illustrating a system for managing chat participants in accordance with some implementations of the present disclosure.

FIG. 2 is a schematic diagram illustrating a system including an integrated working space module in accordance with some implementations of the present disclosure.

FIG. 3 is a block diagram illustrating an overview of devices on which some implementations can operate.

FIG. 4 is a block diagram illustrating an overview of an environment in which some implementations can operate.

FIG. 5 is a flow diagram illustrating a process used in some implementations for outputting alerts on user interfaces.

FIG. 6 is a schematic diagram illustrating a user interface (UI) in some implementations of the present disclosure.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for providing an integrated working space by effectively managing instant message recipients in a group chat environment. For example, the present system enables a user to manage a drop-down list provided by an instant messaging application (e.g., sorting/grouping chat participants therein), such that the user can include one or more chat participants in an integrated working space. In the integrated working space, the user can interact with all the participants (e.g., sending direct messages to each of the participants or two or more of them) and view/manage all relevant documents, contact information, links, technical documents, visual charts, prior correspondences, project timelines, etc.

Aspects of the present disclosure also include methods and systems for managing instant message recipients in a group chat environment. In some implementations, for example, a user can prioritize/sort/group existing chat participants based on one or more characteristics of the chat participants (e.g., in the same group/project/team list; in a relationship (business/friend) list; existing contacts of the user that are in a management group (e.g., “Product Manager” group); existing contacts of the user that are in a sponsor group (e.g., an investor group); existing contacts of the user that are in a product group (e.g., product “X” managed by the user); existing contacts of the user that are in a technology group (e.g., a “database” team); selected contacts based on the user's behavior (e.g., contacts that the user have communicated in the past week, etc.). The present technology enables effective direct messages communications in a group chat environment and thus improve overall system efficiency. In some embodiments, the prioritizing/sorting/grouping processes can be customized based on users'needs.

Another aspect of the present disclosure includes enabling a user to sort, select, or manage chat participants in one or more instant messaging chats. In some embodiments, the user can perform an alphabetical sort with an ability to “pin” or “unpin” one or more chat participants. In some embodiments, the present disclosure enables the user to create a custom ordering for sorting. The custom ordering can be stored and used in the future. In some embodiments, the selection and sorting can be performed by a drag and drop action.

In some embodiments, the present disclosure enables a user to perform a “most-recent” sorting. In such embodiments, the sorting can be done based on a chronicle order (e.g., sorting based on the most recent time that a participant contacted the user). The most recent ordering can also be stored and used in the future (e.g., the user can view/compare/select multiple stored “most recent” sorting events at different time points).

In some embodiments, the present disclosure enables a user to manage “pinned” and “unpinned” sections independently. In one example, a “pinned” section of direct messages can be set to “Custom Sort,” while an unpinned section of direct messages can be set to “Most Recent Sort.” In some embodiments, the “pinned” section can be set “Custom Sort” and the unpinned section can be ser to “Alphabetical Sort.”

Another aspect of the present disclosure enables a user to create groups or subgroups so as to manage chat participants in one or more instant messaging chats. In these embodiments, the user can send direct messages and assign working spaces (e.g., an integrated working space discussed herein) to the created groups/sub-groups. In the assigned working spaces, the user can consolidate chat participants based on various factors/tags such as, Peers, Managers, Functional Groups/Project Teams, Frequent Contacts, Internal/External contacts, etc. In some embodiments, groups and sub-groups can be using an “Add Custom Group” function shown in a user interface.

One aspect of the present disclosure includes providing an integrated working space for chat participants from multiple existing chat groups. For example, user U1 has three existing chat groups U1A, U1B, and U1C. Chat group U1A includes 30 participants, U1A1-U1A30. Chat group U1B includes 40 participants, U1B1-U1B40. Chat group U1C includes 250 participants, U1C1-U1C250. The present system enables user U1 to create an integrated working space for one or more chat participants from one or more of the existing groups by (1) one or more user inputs or actions; (2) one or more search criteria; (3) preset condition/schedules; and (4) other suitable factors.

For example, user U1 can create an integrated working space for three chat participants, U1A13, U1B 33, and U1C222, based on user U1's previous email discussing a potential new project. As another example, user U1 can group 10 chat participants into a new group and grant access of an integrated working space to these 10 chat participants by search conditions (such as, “those who in the same technology group as user U1,” “those who have a specific technical license,” “those who sent more than 20 emails to user U1 in the past month,” etc.).

In another example, an integrated working space can be created based on a preset schedule (e.g., “30 days after user U1 sends an invoice to a recipient, every Monday morning 9:30 a.m., central time, etc.) and/or a preset condition (e.g., contacts from a human resource department working with user U1 in the past two weeks; engineers handled product “X,” contacts from a finance department handling project “Y” etc.). The present system can create the integrated space for the selected chat participants based on the foregoing preset schedules and/or conditions and grant access of the integrated space to them. In some embodiments, access can be in different levels. For example, some documents can be marked as confidential can only be accesses by those who with a specific authorization.

In some embodiments, the multiple existing chat groups can be from two or more different users. For example, in addition to user U1 in the prior example, user U2 can have two existing chat groups U2A and U2B. Chat group U2A includes 300 participants, U2A1-U2A300. Chat group U2B includes 4000 participants, U2B1-U2B4000. The present system can enable either user U1 or user U2 to create an integrated working space for one or more chat participants from chat groups U1A, U1B, U1C, U2A and U2B by (1) one or more user inputs; (2) one or more search criteria; (3) preset condition/schedules, as previously discussed; and (4) other suitable factors.

In some embodiments, the chat participants can be selected based on characteristics involving users U1 and U2. Such examples include those who send emails to both users U1 and U2 with a keyword “product X,” those who have been copied in more than 50 emails where both users U1 and U2 are recipients, etc.

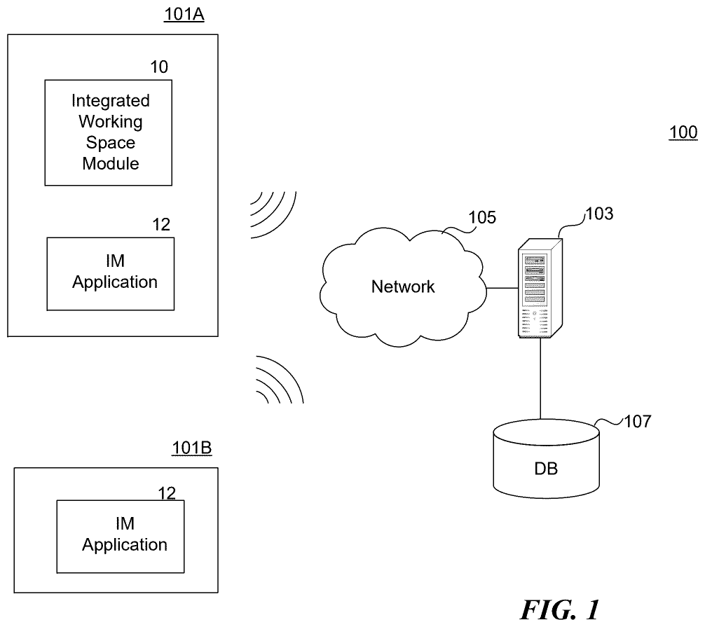

Several implementations are discussed below in more detail in reference to the figures. FIG. 1 is a schematic diagram illustrating a system 100 for managing chat participants in accordance with some implementations of the present disclosure. Two computing devices 101A and 101B are used by different chat participants to communicate with each other via a network 105. Although only two computing devices 101A, 101B are shown in FIG. 1, in other embodiments, there can be more than two computing devices in the system 100.

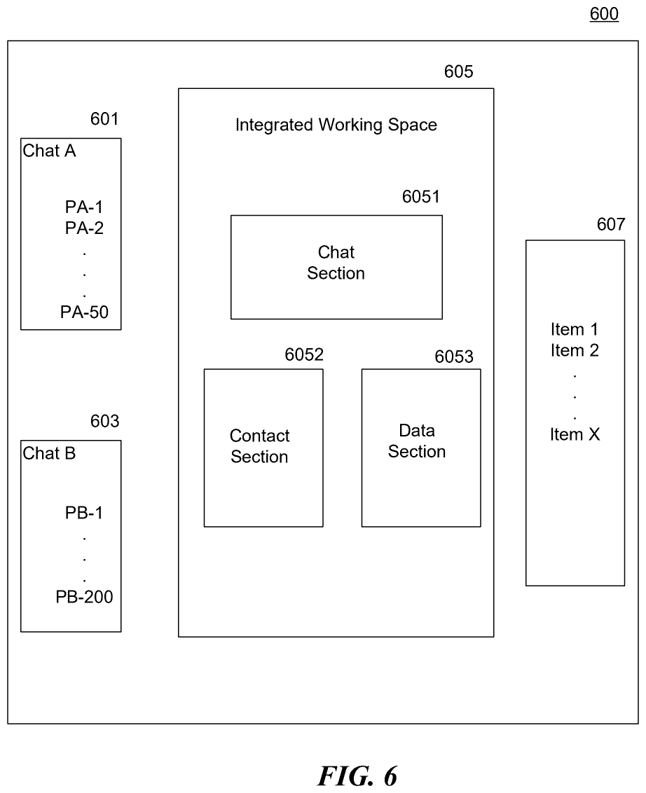

The computing device 101A includes an integrated working space module 10. The integrated working space module 10 is configured to provide an integrated working space for the user of the computing device 101A to effectively manage instant message recipients in a group chat environment. Embodiments of the integrated working space are discussed in detail with reference to FIG. 6. Both the computing devices 101A and 101B include an instant messaging application 12 configured to communicate with other users by instant messages via the network 105. In some embodiments, the network 105 can communicate via various types of communication protocols, such as WiFi, 5G, LTE, 3GPP, etc.

As shown in FIG. 1, the computing devices 101A and 101B can communicate with a server 103 via the network 105. The server 103 can further connect to a database 107. The database 107 is configured to store data related to the computing devices 101A and 101B, as well as data analyzed or trained by the server 103. In some embodiments, the server 103 can analyze and train (e.g., by one or more machine learning or artificial intelligence schemes) the data related to the computing devices 101A and 101B so as to form a communication model. In some embodiments, the communication model can facilitate instant message communications by providing suitable user interface suggestion, relevant chat participants that may be included, potentially relevant documents/links to be included in an integrated working space, etc.

In some embodiments, the integrated working space module 10 enables the user of the computing device 101A to manage one or more drop-down lists provided by the instant messaging application 12. In some embodiments, the drop-down lists can be from different instant messaging applications. The integrated working space module 10 enables the user to create an integrated working space for all intended participants (e.g., chosen by the user or recommended by the system 100). The user can then effectively interact with all the intended participants in one place, including sending direct messages to one or more the participants as well as viewing/managing relevant documents, contact information, links, technical documents, visual charts, prior correspondences, project timelines, etc. at the same time.

In some embodiments, the integrated working space module 10 enables the user to prioritize/sort/group existing chat participants based on one or more characteristics of the chat participants. In some embodiments, the characteristics can include group/project/team assignments, business/personal relationships, existing/non-existing contacts, management roles, financial roles, technical roles, prior user histories/preferences, etc. By the foregoing arrangement, the integrated working space module 10 enables effective communications in a group chat environment (e.g., via the integrated working space, to be discussed in detail with reference to FIG. 6) and thus improve overall system efficiency.

In some embodiments, the integrated working space allows chat participants from multiple existing chat groups to participant. In some embodiments, the multiple existing chat groups can be from the same instant message applications (e.g., IM application 12). In some embodiments, the multiple existing chat groups can be from different instant messaging applications.

In some embodiments, the integrated working space module 10 can be implemented as a plug-in, an extension, a function, or a sub-routine for the IM application 12. In some embodiments, the integrated working space module 10 can be implemented as a separate application.

In some implementations, the integrated working space can be created based on one or more user inputs, one or more search criteria, preset conditions/schedules, etc. For example, a user can create the integrated working space by manually select multiple chat participants from existing chats via a user interface. Embodiments of the user interface are discussed in detail below with reference to FIG. 6.

In some embodiments, the search criteria can include key words, relationships, task/role assignments, etc. In some examples, the preset schedules can include a time schedule, a project schedule, a finance schedule, etc. In some examples, the preset conditions can be based on timing, events, incidents, relationships, task/role assignments, etc.

In some embodiments, access to the integrated working space can be managed in different security levels. For example, some documents can be marked as confidential can only be accesses by those who with a specific authorization. In some embodiments, multiple authentication processes can be performed before granting the access.

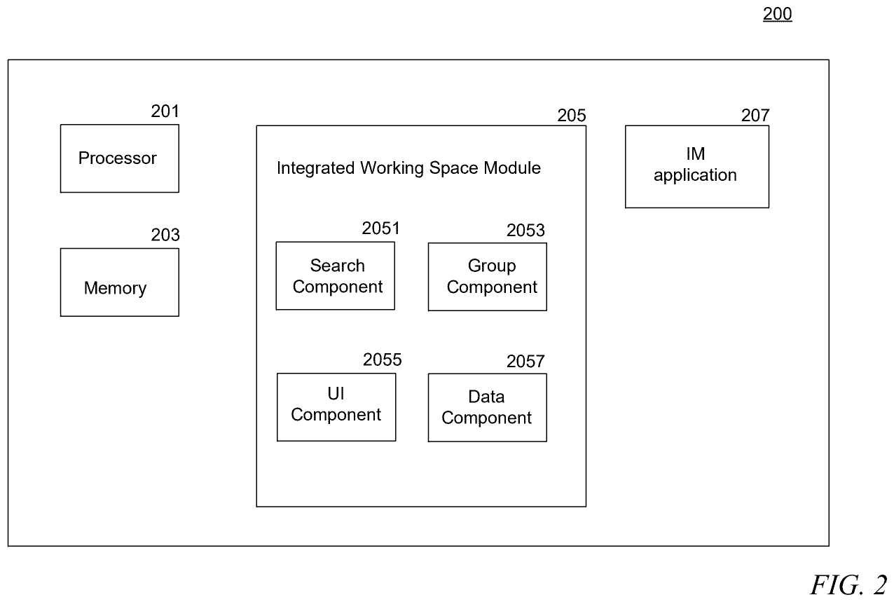

FIG. 2 is a schematic diagram illustrating a system 200 including an integrated working space module 205 in accordance with some implementations of the present disclosure. As shown in FIG. 2, the system 200 also includes a processor 201, a memory 203, and an instant message application 207. The processor 201 is configured to control and communicate other components in the system 200. The memory 203 is coupled to the processor and configured to store data or information associated with the system 200. The instant message application 207 is configured to enable a user of the system 200 to communicate with others via instant messages.

As shown, the integrated working space module 205 includes a search component 2051, a group component 2053, a user interface (UI) component 2055, and a data management component. The search component 2051 is configured to search chat participants or contacts based on user inputs, preset conditions/schedules, any other suitable factors. The group component 2053 is configured to group or sort one or more chat participants based on a preset order or priority rules from user inputs. In some embodiments, the search component 2051 and the group component 2053 can be integrated into one component.

The user interface component 2055 is configured to visually present and arrange an integrated working space provided by the integrated working space module 205. Embodiments of a user interface provided by the user interface component 2055 are discussed below with reference to FIG. 6.

The data component 2057 is configured to manage data associated with the integrated working space module 205. For example, such data can include search histories, user preferences, preset conditions/schedules, generated groups and associated documents/links, user interface configurations, hardware/software settings, data for training a machine learning model, etc.

As shown in FIG. 2, the system 200 includes an instant messaging application 207 (e.g., Google Chat®). In the illustrated embodiments, the integrated working space module 205 and the instant messaging application 207 are separate components. In some embodiments, the integrated working space module 205 and the instant messaging application 207 can be implemented and integrated into one application/component/module.

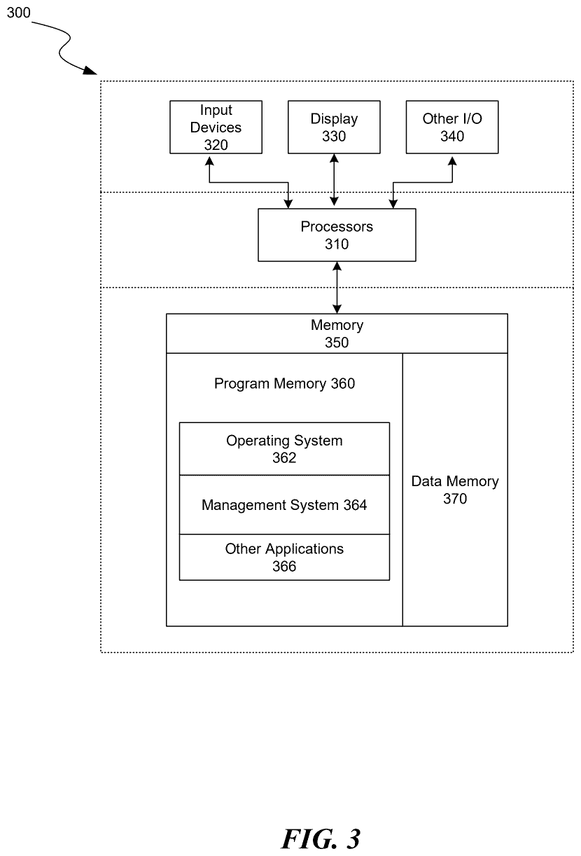

FIG. 3 is a block diagram illustrating an overview of devices (e.g., computing device 101A and system 200) on which some implementations can operate. The devices can comprise hardware components of a device 300 that generate and manage integrated working spaces for instant message chat participants. Device 300 can include one or more input devices 320 that provide input to the processor(s) 310 (e.g., CPU(s), GPU(s), etc.), notifying it of actions. The actions can be mediated by a hardware controller that interprets the signals received from the input device and communicates the information to the processors 310 using a communication protocol. Input devices 320 include, for example, a mouse, a keyboard, a touchscreen, an infrared sensor, a touchpad, a wearable input device, a camera- or image-based input device, a microphone, or other user input devices.

Processors 310 can be a single processing unit or multiple processing units in a device or distributed across multiple devices. In some embodiments, the processors 310 can be coupled to other hardware devices, for example, with the use of a bus, such as a PCI bus or SCSI bus. The processors 310 can communicate with a hardware controller for devices, such as for a display 330. Display 330 can be used to display text and graphics. In some implementations, the display 330 provides graphical and textual visual feedback to a user. In some implementations, the display 330 can include the input device as part of the display, such as when the input device is a touchscreen or is equipped with an eye direction monitoring system. In some implementations, the display 330 can be separate from the input device 320. Examples of the display devices include an LCD (liquid crystal display) screen, an LED (light-emitting diode) display screen, a projected, holographic, or augmented reality display (such as a heads-up display device or a head-mounted device), and so on. Other I/O devices 340 can also be coupled to the processor 310, such as a network card, video card, audio card, USB, firewire or other external device, camera, printer, speakers, CD-ROM drive, DVD drive, disk drive, or Blu-Ray device.

In some implementations, the device 300 also includes a communication device capable of communicating wirelessly or wire-based with a network node. The communication device can communicate with another device or a server through a network using, for example, TCP/IP protocols. Device 300 can utilize the communication device to distribute operations across multiple network devices.

The processors 310 can have access to a memory 350 in a device or distributed across multiple devices. A memory includes one or more of various hardware devices for volatile and non-volatile storage and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 350 can include a program memory 360 that stores programs and software, such as an operating system 362, a management system 364 (e.g., for implementing the methods for managing IM participants discussed herein), and other application programs 366. Memory 350 can also include data memory 370, user interface data, event data, image data, biometric data, sensor data, device data, location data, network learning data, application data, alert data, structure data, camera data, retrieval data, management data, notification data, configuration data, settings, user options or preferences, etc., which can be provided to the program memory 360 or any element of the device 300.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

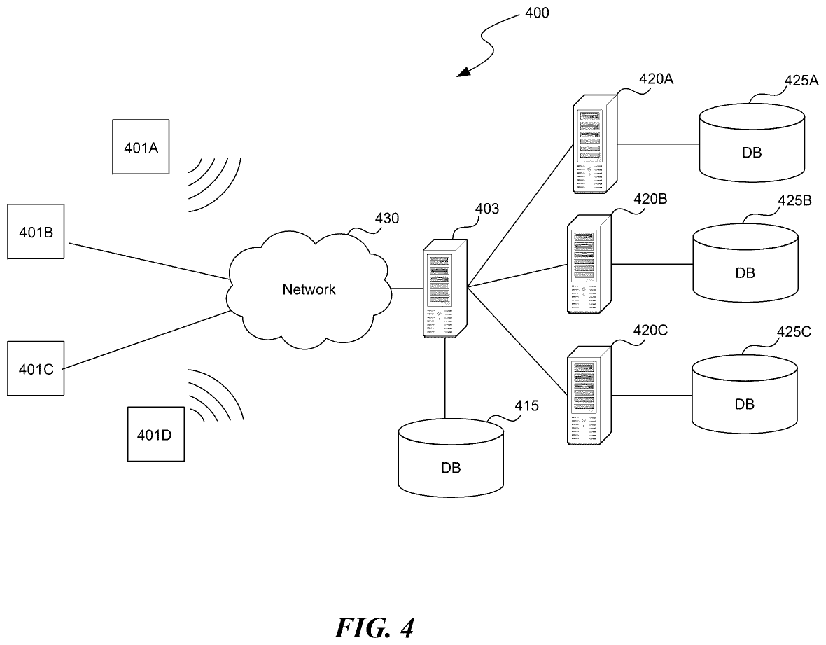

FIG. 4 is a block diagram illustrating an overview of an environment 400 in which some implementations can operate. Environment 400 can include one or more client computing devices 401A-D, examples of which can include the computing devices 101A, 101B and system 200. Client computing devices 401 can operate in a networked environment using logical connections through network 430 to one or more remote computers, such as a server computing device 403.

In some implementations, the server computing device 403 can be an edge server which receives client requests and coordinates fulfillment of those requests through other servers, such as servers 420A-C. Server computing devices 403 and 420 can comprise computing systems, such as the device 300 discussed above. Though each server computing device 403 and 420 is displayed logically as a single server, server computing devices can each be a distributed computing environment encompassing multiple computing devices located at the same or at geographically disparate physical locations. In some implementations, each server 420 corresponds to a group of servers.

The client computing devices 401 and the server computing devices 403 and 420 can each act as a server or client to other server/client devices. Server 403 can connect to a database 415. Servers 420A-C can each connect to a corresponding database 425A-C. As discussed above, each server 420 can correspond to a group of servers, and each of these servers can share a database or can have their own databases.

Databases 415/425 can store information such as implement data, user interface data, event data, image data, detection data, biometric data, sensor data, device data, location data, network learning data, application data, alert data, structure data, camera data, retrieval data, management data, notification data, configuration data. Though databases 415/425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN) but can also be other wired or wireless networks. Network 430 may be the Internet or some other public or private network. Client computing devices 401 can be connected to network 430 through a network interface, such as by wired or wireless communication. While the connections between server 403 and servers 420 are shown as separate connections, these connections can be any kind of local, wide area, wired, or wireless network, including network 430 or a separate public or private network.

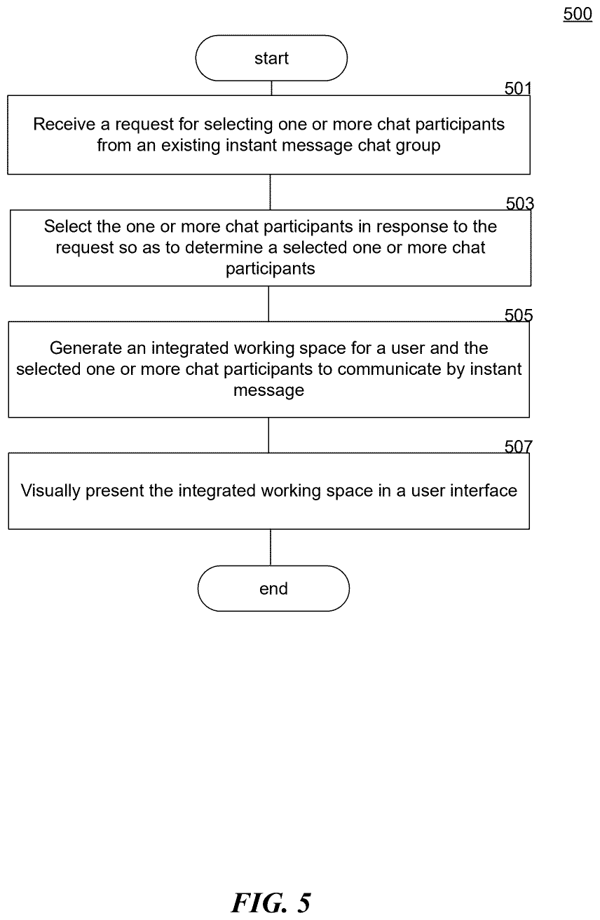

FIG. 5 is a flow diagram illustrating a method 500 used in some implementations for outputting alerts on user interfaces. In some embodiments, the method 500 can be implemented by a device (e.g., the computing device 101A, system 200, etc.) discussed herein. At step 501, the method 500 receives, at a computing device of a user, a request for selecting one or more chat participants from an existing instant message chat group.

In some embodiments, the request can be received by a computing device of a user (e.g., a mobile device, a desktop computer, a laptop computer, etc.). At step 503, the method 500 includes selecting (e.g., at the computing device) the one or more chat participants in response to the request so as to determine a selected one or more chat participants. The selected chart participants can be sorted or grouped. In some embodiments, the sorting/grouping can be customized, and the results thereof can be stored. In some embodiments, the selection can be based on a user action (e.g., dragging a username from a list and dropping it to another area on a user interface), a user input (e.g., input the first two characters of the participant's name or email address), a search criterion (e.g., key words), a present condition (e.g., contacts handled “Project Y”), or a preset schedule (e.g., contacts that frequently send status report in a chat every Monday).

At step 505, the method 500 generates (e.g., at the computing device) an integrated working space for the user and the selected one or more chat participants to communicate by instant message. At step 507, the method 500 visually presents the integrated working space in a user interface (e.g., on the computing device).

In some embodiments, the one or more chat participants can be first participants, and the existing instant message chat group can be a first existing chat group from a first instant messaging application. In such embodiments, the method 500 can further includes selecting the one or more second participants from a second existing chat group as a part of the one or more selected chat participants.

In some examples, the second existing chat group can also be from the first instant messaging application. In other example, the second existing chat group can be from a second (different) instant messaging application. In some embodiments, the method 500 further comprises authenticating the selected one or more chat participants before granting access to the integrated working space.

In some embodiments, the user interface can include a chat drop-down list, and the method 500 includes selecting the one or more chat participants from the chat drop-down list. In some implementations, the user interface can include a first chat drop-down list and a second chat drop-down list. In such embodiments, the method 500 includes selecting the one or more chat participants from the first chat first chat drop-down list and/or the second chat drop-down list.

In some embodiments, the integrated working space in the user interface includes a chat section. The chat section can be configured to display conversations or chats among the selected participants.

In some embodiments, the integrated working space in the user interface can include a contact section. The contact section can be configured to display selected participants and/or candidates of the participants to be selected.

In some embodiments, the integrated working space in the user interface includes a data section. The data section can be configured to display information associated with the conversations or the chats shown in the chat section, as well as information regarding the selected participants or the candidates shown in the contact section.

In some embodiments, the user interface includes a side section. The side section can be configured to show multiple items to be added to the integrated working spaces. For example, such multiple items can include, links, documents, audio/video contents, any other suitable items that are not currently in but can be added to the integrated working space. Embodiments of the chat section, the contact section, the data section, and the side section are discussed in detail with reference to FIG. 6.

FIG. 6 is a schematic diagram illustrating a user interface (UI) 600 in some implementations of the present disclosure. As shown, the user interface 600 includes a first chat drop-down list 601 and a second chat drop-down list 602. The first chat drop-down list 601 visually presents participants PA-1 to PA-50 in group Chat A. The second chat drop-down list 603 visually presents participants PB-1 to PA-200 in group Chat B. In some embodiments, a user can select one or more of the participants to an integrated working space 605 by selecting and dragging the selected participants from the first chat drop-down list 601 and the second chat drop-down list 602. In other embodiments, candidates of the participants to be selected can be presented in the integrated working space 605 for the user to select.

In the illustrated embodiments, only two drop-down lists are shown. In other embodiments, the user interface 600 can have a single drop-down list or more than two drop-down lists.

In the illustrated embodiment of FIG. 6, the integrated working space 605 includes a chat section 6051, a contact section 6052, and a data section 6053. The chat section 6051 is configured to display conversations or chats among the selected participants. The contact section 6052 is configured to display selected participants and/or candidates of the participants to be selected.

For example, conversations between the user, participant PA-5, and participant PB-23 can be shown in the chat section 6051. At the same time, information regarding participant PA-5 (e.g., title, phone number, email address, office location, department, etc.) and participant PB-23 (e.g., prior projects handed in the past five years) can be shown in the contact section 6052.

As one example, in the conversations shown in the chat section 6051, “participant PB-150” can be mentioned and then participant PB-150 can be presented in the contact section 6052 as a candidate for the user to determine whether to include that participant to the chat shown in the chat section 6051. Information associated with participant PB-150 can also be presented in the contact section so as to facilitate the user's decision.

The data section 6053 is configured to display information associated with the conversations or the chats shown in the chat section 6051, as well as information regarding the selected participants or the candidates shown in the contact section 6052. For example, in an event that “Product X” is mentioned in the conversation, relevant links and documents can be presented in the data section 6053. As another example, in an event that a candidate is presented in the contact section 6052, a social medial link of that candidate or other documents related to the candidate can also be shown in the data section 6053.

The foregoing arrangements and configurations enable the user to effectively management multiple chat participants from various existing chats. Relevant information can also be presented in the contact section 6052 and the data section 6053 close sections such at the user can keep the conversations going in the chat section 6051 while having relevant information available nearby.

As shown in the illustrated embodiment, the user interface 600 includes a side section 607 showing multiple items 1-X to be added to the integrated working spaces. The multiple items can include, for example, links, documents, audio/video contents, any other suitable items that are not currently in but can be added to the integrated working space 605. For example, an email review panel can be shown in the side section 607 such that the user can review emails at the same time. In some embodiments, another chat group (with additional participants) can also be shown in this second for the user to select. In some embodiments, the user interface 600 can be implemented without the side section 607.

Those skilled in the art will appreciate that the components illustrated in FIGS. 1-6 described above, and in each of the flow diagrams discussed below, may be altered in a variety of ways. For example, the order of the steps may be rearranged, sub-steps may be performed in parallel, illustrated steps may be omitted, other steps may be included, etc. In some implementations, one or more of the components described in a user interface can be rearranged.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

Unless explicitly excluded, the use of the singular to describe a component, structure, or operation does not exclude the use of plural such components, structures, or operations. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method, comprising:
receiving, at a computing device of a user, a request for selecting one or more chat participants from an existing instant message chat group;
selecting, at the computing device, the one or more chat participants in response to the request so as to determine a selected one or more chat participants;
generating, at the computing device, an integrated working space for the user and the selected one or more chat participants to communicate by instant message; and
visually presenting the integrated working space in a user interface on the computing device.

2. The method of claim 1, further comprising:
selecting the one or more chat participants based on a user action so as to sort or group the one or more chat participants.

3. The method of claim 1, further comprising:
selecting the one or more chat participants based on a user input so as to sort or group the one or more chat participants.

4. The method of claim 1, further comprising:
selecting the one or more chat participants based on a search criterion so as to sort or group the one or more chat participants.

5. The method of claim 1, further comprising:
selecting the one or more chat participants based on a preset condition so as to sort or group the one or more chat participants.

6. The method of claim 1, further comprising:
selecting the one or more chat participants based on a preset schedule so as to sort or group the one or more chat participants.

7. The method of claim 1, wherein the one or more chat participants are first participants, wherein the existing instant message chat group is a first existing chat group from a first instant messaging application, and the method further comprises:
selecting, at the computing device, the one or more second participants from a second existing chat group as a part of the one or more selected chat participants.

8. The method of claim 7, wherein the second existing chat group is from the first instant messaging application.

9. The method of claim 7, wherein the second existing chat group is from a second instant messaging application.

10. The method of claim 1, further comprising:
authenticating the selected one or more chat participants before granting access to the integrated working space.

11. The method of claim 1, wherein the user interface includes a chat drop-down list, and wherein the method includes selecting the one or more chat participants from the chat drop-down list.

12. The method of claim 1, wherein the user interface includes a first chat drop-down list and a second chat drop-down list, and wherein the method includes selecting the one or more chat participants from the first chat first chat drop-down list or the second chat drop-down list.

13. The method of claim 1, wherein the integrated working space in the user interface includes a chat section.

14. The method of claim 1, wherein the integrated working space in the user interface includes a contact section.

15. The method of claim 1, wherein the integrated working space in the user interface includes a data section.

16. The method of claim 1, wherein the user interface includes a side section.

17. A computing system comprising:
at least one processor; and
at least one memory storing instructions that, when executed by the processor, cause the computing system to perform a process comprising:
receiving, at a computing device of a user, a request for selecting one or more chat participants from an existing instant message chat group;
selecting, at the computing device, the one or more chat participants in response to the request so as to determine a selected one or more chat participants;
generating, at the computing device, an integrated working space for the user and the selected one or more chat participants to communicate by instant message; and
visually presenting the integrated working space in a user interface on the computing device.

18. The computing system of claim 17, wherein the process further comprises:
selecting the one or more chat participants based on a user action, a user input, a search criterion, a preset condition, or a preset schedule.

19. The computing system of claim 17, wherein the user interface includes a first chat drop-down list and a second chat drop-down list, and wherein the method includes selecting the one or more chat participants from the first chat first chat drop-down list or the second chat drop-down list.

20. A non-transitory computer-readable medium storing instructions that, when executed by a computing system, cause the computing system to perform operations comprising:
receiving, at a computing device of a user, a request for selecting one or more chat participants from an existing instant message chat group;
selecting, at the computing device, the one or more chat participants in response to the request so as to determine a selected one or more chat participants;
generating, at the computing device, an integrated working space for the user and the selected one or more chat participants to communicate by instant message; and
visually presenting the integrated working space in a user interface on the computing device.
